(19) United States
(12) Patent Application Publication
(10) Pub. No.: US 2024/0145921 A1
(43) Pub. Date: May 2, 2024

(54) Antenna Package

(71) Applicant: Ticona LLC, Florence, KY (US)

(72) Inventor: Young Shin Kim, Cincinnati, OH (US)

(21) Appl. No.: 18/483,538

(22) Filed: Oct. 10, 2023

Related U.S. Application Data
(60) Provisional application No. 63/415,788, filed on Oct. 13, 2022.

(51) Int. Cl. H01Q 9/04

(52) U.S. Cl. CPC H01Q 9/0407; H01Q 1/2283

(57) ABSTRACT

An antenna package that contains a substrate, an antenna containing one or more antenna elements positioned adjacent to a first side of the substrate. The antenna is configured to transmit and/or receive wireless communications at a millimeter wave frequency, and the antenna is electrically coupled to a semiconductor device through the substrate. The substrate comprises a polymer composition, wherein the polymer composition includes a polymer matrix containing a thermotropic liquid crystalline polymer, wherein the polymer composition exhibits a dissipation factor of about 0.1 or less as determined at a frequency of 17 GHz and a dielectric constant of about 4 more as determined at a frequency of 17 GHz.

### RELATED APPLICATION

The present application is based upon and claims priority to U.S. Provisional Patent Application Ser. No. 63/415,788, having a filing date of Oct. 13, 2022, which is incorporated herein by reference.

### BACKGROUND OF THE INVENTION

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., LTE or WiMax). A fifth generation (5G) mobile standard calls for higher data transfer speeds, greater numbers of connections, and better coverage, among other improvements. To address at least some of these goals, antenna-in-packages (“AiP”) are often employed that use a phased array antenna to concentrate radio energy in a narrow, directional beam, thereby increasing gain without increasing transmission power. The antenna is generally disposed on a glass substrate in which through-hole vias are formed to allow electrical connection to an integrated circuit within the package. Unfortunately, one of the problems associated with such packages is that it is difficult to form glass substrates with small thickness values, which is often desired for very high frequency applications. Further, it is often complex and costly to manufacture antenna packages with such substrates. As such, a need currently exists for an improved antenna package for use in very high frequency applications.

### SUMMARY OF THE INVENTION

In accordance with one embodiment of the present invention, an antenna package is disclosed that comprises a substrate and an antenna containing one or more antenna elements positioned adjacent to a first side of the substrate. The antenna is configured to transmit and/or receive wireless communications at a millimeter wave frequency and is electrically coupled to a semiconductor device through the substrate. The substrate comprises a polymer composition that includes a polymer matrix containing a thermotropic liquid crystalline polymer. The polymer composition exhibits a dissipation factor of about 0.1 or less as determined at a frequency of 17 GHz and a dielectric constant of about 4 more as determined at a frequency of 17 GHz.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 illustrates one embodiment of the antenna package of the present invention;

FIG. 2 illustrates another embodiment of the antenna package of the present invention;

FIG. 3 shows the dielectric constant of the Example over a frequency range of 17 GHz to 60 GHz in comparison to a conventional glass substrate; and

FIG. 4 shows the dissipation factor of the Example over a frequency range of 17 GHz to 60 GHz in comparison to a conventional glass substrate.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to an antenna package that comprises a substrate and an antenna containing one or more antenna elements positioned adjacent to a substrate. The antenna is configured to transmit and/or receive wireless communications at a millimeter wave frequency. A semiconductive device (e.g., monolithic microwave integrated circuit) is electrically coupled to the antenna through the substrate. Notably, the substrate comprises a polymer composition that includes a polymer matrix containing a thermotropic liquid crystalline polymer. By selectively controlling various aspects of the composition, the present inventor has discovered that the resulting composition is able to maintain a unique combination of a high dielectric constant and low dissipation factor for use in the substrate. For example, the polymer composition may exhibit a high dielectric constant of about 4 or more, in some embodiments about 4.5 or more, in some embodiments about 5 or more, in some embodiments from about 5.5 to about 15, and in some embodiments, from about 6 to about 12, as determined by the Fabry-Perot open resonator (FPOR) method. Such a high dielectric constant can facilitate the ability to form a thin layer and also allow the conductive elements of the antenna package (e.g., antenna elements, redistribution layer, etc.) to operate simultaneously with only a minimal level of electrical interference. The dissipation factor, a measure of the loss rate of energy, may also be relatively low, such as about 0.1 or less, in some embodiments about 0.08 or less, in some embodiments about 0.05 or less, in some embodiments about 0.04 or less, in some embodiments about 0.03 or less, in some embodiments about 0.02 or less, in some embodiments from 0 to about 0.01, and in and in some embodiments, from about 0.0001 to about 0.008, as determined by the Fabry-Perot open resonator (FPOR) method. Notably, the dielectric constant and/or dissipation factor can be maintained within the ranges noted above even at the high frequency bands intended for 5G/6G systems. 5G systems, for example, may employ centimeter wave communications (frequency spectrum of from 3 to 30 GHz) or millimeter wave communications (30 to 300 GHz). It is anticipated that 6G systems will employ millimeter wave communications or Terahertz radiation (300 to 3000 GHz). In this regard, the dielectric constant and/or dissipation factor of the polymer composition can be maintained within the ranges noted above, such as at a frequency of 17 GHz. In some cases, such values may be maintained over a broad frequency range, such as from 17 GHz to 60 GHz. In one embodiment, for example, the ratio of the dielectric constant and/or dissipation factor at 60 GHz to the respective dielectric constant and/or dissipation factor at 16 GHz may be from about 0.7 to about 1.3, in some embodiments from about 0.8 to about 1.2, and in some embodiments, from about 0.9 to about 1.1.

Conventionally, it was believed that polymer compositions that possess the combination of a high dielectric constant and low dissipation factor would not also possess a sufficiently low melt viscosity to so that it can readily flow into the cavity of a mold to form a small-sized substrate for use in an antenna package. Contrary to conventional thought, however, the polymer composition has been found to possess excellent melt processability. For example, the polymer composition generally has an ultralow melt viscosity, such as from about 0.1 to about 150 Pa-s, in some embodiments from about 0.2 to about 100 Pa-s, in some embodiments from about 0.3 to about 50 Pa-s, and in some embodiments, from about 0.5 to about 40 Pa-s, as determined at a shear rate of 1,000 seconds⁻¹ and temperature of about 15° C. greater than the melting temperature of the polymer composition in accordance with ISO 11443:2021.

The polymer composition may also have excellent thermal properties. The melting temperature of the composition may, for instance, be from about 230° C. to about 400° C., in some embodiments from about 250° C. to about 380° C., and in some embodiments, from about 260° C. to about 350° C. Even at such melting temperatures, the ratio of the deflection temperature under load (“DTUL”), a measure of short term heat resistance, to the melting temperature may still remain relatively high. For example, the ratio may range from about 0.5 to about 1.00, in some embodiments from about 0.6 to about 0.95, and in some embodiments, from about 0.65 to about 0.85. The specific DTUL values may, for instance, be about 220° C. or more, in some embodiments from about 230° C. to about 300° C., and in some embodiments, from about 240° C. to about 280° C. Such high DTUL values can, among other things, allow the use of high speed and reliable surface mounting processes for mating the structure with other components of the electrical component.

The polymer composition may also possess a high impact strength, which is useful when forming thin substrate layers. The composition may, for instance, possess a Charpy notched impact strength of about 0.5 kJ/m² or more, in some embodiments from about 1 to about 50 kJ/m², in some embodiments from about 2 to about 30 kJ/m², and in some embodiments, from about 3 to about 25 kJ/m², as determined at a temperature of 23° C. in accordance with ISO Test No. ISO 179-1:2010. The tensile and flexural mechanical properties of the composition may also be good. For example, the polymer composition may exhibit a tensile strength of from about 20 to about 500 MPa, in some embodiments from about 50 to about 400 MPa, and in some embodiments, from about 70 to about 350 MPa; a tensile break strain of about 0.4% or more, in some embodiments from about 0.5% to about 10%, and in some embodiments, from about 0.6% to about 3.5%; and/or a tensile modulus of from about 5,000 MPa to about 20,000 MPa, in some embodiments from about 8,000 MPa to about 20,000 MPa, and in some embodiments, from about 10,000 MPa to about 20,000 MPa. The tensile properties may be determined at a temperature of 23° C. in accordance with ISO 527:2019. The polymer composition may also exhibit a flexural strength of from about 20 to about 500 MPa, in some embodiments from about 50 to about 400 MPa, and in some embodiments, from about 100 to about 350 MPa; a flexural elongation of about 0.4% or more, in some embodiments from about 0.5% to about 10%, and in some embodiments, from about 0.6% to about 3.5%; and/or a flexural modulus of from about 5,000 MPa o about 20,000 MPa, in some embodiments from about 8,000 MPa to about 20,000 MPa, and in some embodiments, from about 10,000 MPa to about 15,000 MPa. The flexural properties may be determined at a temperature of 23° C. in accordance with ISO 178:2019.

Various embodiments of the present invention will now be described in more detail.

### I. Polymer Composition

### A. Polymer Matrix

The polymer matrix contains one or more thermotropic liquid crystalline polymers. Liquid crystalline polymers are generally classified as “thermotropic” to the extent that they can possess a rod-like structure and exhibit a crystalline behavior in their molten state (e.g., thermotropic nematic state). The liquid crystalline polymers employed in the polymer composition typically have a melting temperature of from about 280° C. to about 400° C., in some embodiments from about 290° C. to about 380° C., and in some embodiments from about 300° C. to about 350° C. The melting temperature may be determined as is well known in the art using differential scanning calorimetry (“DSC”), such as determined by ISO 11357-3:2018. Such polymers may be formed from one or more types of repeating units as is known in the art. A liquid crystalline polymer may, for example, contain one or more aromatic ester repeating units generally represented by the following Formula (I):

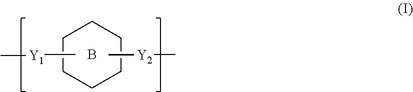

wherein,
ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and
Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute from about 20 mol. % to about 85 mol. %, in some embodiments from about about 30 mol. % to about 80 mol. %, and in some embodiments, from about 40 mol. % to 75 mol. % of the polymer.

Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 1 mol. % to about 50 mol. %, in some embodiments from about 5 mol. % to about 40 mol. %, and in some embodiments, from about 10 mol. % to about 35 mol. % of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 50 mol. %, in some embodiments from about 5 mol. % to about 40 mol. %, and in some embodiments, from about 10 mol. % to about 35 mol. % of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

Although not necessarily required, at least one liquid crystalline polymer is typically employed in the polymer matrix that is a “high naphthenic” polymer to the extent that it contains a relatively high content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically about 10 mol. % or more, in some embodiments about 15 mol. % or more, in some embodiments from about 20 mol. % to about 80 mol. %, in some embodiments from about 30 mol. % to about 70 mol. %, and in some embodiments, from about 40 mol. % to about 60 mol. % of the polymer. Contrary to many conventional “low naphthenic” polymers, it is believed that the resulting “high naphthenic” polymers are capable of exhibiting good thermal and mechanical properties.

In one particular embodiment, for instance, the liquid crystalline polymer may contain repeating units derived from HNA in an amount from 20 mol. % to about 80 mol. %, in some embodiments from about 30 mol. % to about 70 mol. %, and in some embodiments, from about 40 mol. % to about 60 mol. %. The liquid crystalline polymer may also contain various other monomers. For example, the polymer may contain repeating units derived from HBA in an amount of from about 0.1 mol. % to about 15 mol. %, and in some embodiments from about 0.5 mol. % to about 10 mol. %, and in some embodiments, from about 1 mol. % to about 5 mol. %. When employed, the molar ratio of repeating units derived from HBA to the repeating units derived from HNA may be selectively controlled within a specific range to help achieve the desired properties, such as from about 5 to about 40, in some embodiments from about 10 to about 35, and in some embodiments, from about 20 to about 30. The polymer may also contain repeating units derived from aromatic dicarboxylic acid(s) (e.g., IA and/or TA) in an amount of from about 10 mol. % to about 40 mol. %, and in some embodiments, from about 20 mol. % to about 30 mol. %; and/or aromatic diol(s) (e.g., BP and/or HQ) in an amount of from about 10 mol. % to about 40 mol. %, and in some embodiments, from about 20 mol. % to about 30 mol. %. In some cases, however, it may be desired to minimize the presence of such monomers in the polymer to help achieve the desired properties. For example, the total amount of repeating units derived from aromatic dicarboxylic acid(s) (e.g., IA and/or TA) and/or aromatic diols (e.g., BP and/or HQ) may be about 5 mol % or less, in some embodiments about 4 mol. % or less, and in some embodiments, from about 0.1 mol. % to about 3 mol. %, of the polymer.

Regardless of the particular constituents and nature of the polymer, the liquid crystalline polymer may be prepared by initially introducing the aromatic monomer(s) used to form the ester repeating units (e.g., aromatic hydroxycarboxylic acid, aromatic dicarboxylic acid, etc.) and/or other repeating units (e.g., aromatic diol, aromatic amide, aromatic amine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 200° C. to about 400° C. For instance, one suitable technique for forming the aromatic polyester may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 200° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. In some embodiments, the melt polymerized polymer may also be subjected to a subsequent solid-state polymerization method to further increase its molecular weight. Solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 200° C. to about 400° C. The polymerization time will of course vary based on the temperature and target molecular weight. In most cases, however, the solid-state polymerization time will be from about 2 to about 12 hours, and in some embodiments, from about 4 to about 10 hours.

The total amount of liquid crystalline polymers employed in the polymer composition is typically from about 30 wt. % to about 90 wt. %, in some embodiments from about 35 wt. % to about 80 wt. %, and in some embodiments, from about 40 wt. % to about 60 wt. % of the entire polymer composition. In certain embodiments, all of the liquid crystalline polymers are “high naphthenic” polymers such as described above. In other embodiments, however, “low naphthenic” liquid crystalline polymers may also be employed in the composition in which the total amount of repeating units derived from naphthenic hydroxycarboxylic and/or dicarboxylic acids (e.g., NDA, HNA, or a combination of HNA and NDA) is less than 10 mol. %, in some embodiments about 8 mol. % or less, in some embodiments about 6 mol. % or less, and in some embodiments, from about 1 mol. % to about 5 mol. % of the polymer. When employed, it is generally desired that such low naphthenic polymers are present in only a relatively low amount. For example, when employed, low naphthenic liquid crystalline polymers typically constitute from about 1 wt. % to about 50 wt. %, in some embodiments from about 10 wt. % to about 45 wt. %, and in some embodiments, from about 20 wt. % to about 40 wt. % of the total amount of liquid crystalline polymers in the composition, and from about 0.5 wt. % to about 45 wt. %, in some embodiments from about 2 wt. % to about 35 wt. %, and in some embodiments, from about 5 wt. % to about 25 wt. % of the entire composition. Conversely, high naphthenic liquid crystalline polymers typically constitute from about 50 wt. % to about 99 wt. %, in some embodiments from about 55 wt. % to about 95 wt. %, and in some embodiments, from about 60 wt. % to about 90 wt. % of the total amount of liquid crystalline polymers in the composition, and from about 25 wt. % to about 65 wt. %, in some embodiments from about 30 wt. % to about 60 wt. %, and in some embodiments, from about 35 wt. % to about 55 wt. % of the entire composition.

### B. Optional Additives

i. Dielectric Filler

To help achieve the desired dielectric properties, the polymer composition may optionally contain a dielectric filler. When employed, the dielectric filler may be present in an amount of from about 10 wt. % to about 60 wt. %, in some embodiments from about 15 wt. % to about 55 wt. %, and in some embodiments, from about 20 wt. % to about 50 wt. % of the composition. In certain embodiments, it may be desirable to selectively control the electrical properties of the dielectric filler to help achieve the desired results. For example, the dielectric constant of the material may be about 20 or more, in some embodiments about 40 or more, and in some embodiments, about 50 more as determined at a frequency of 1 MHz. High dielectric constant materials may be employed in certain embodiments, such as from about 1,000 to about 15,000, in some embodiments from about 3,500 to about 12,000, and in some embodiments, from about 5,000 to about 10,000, as determined at a frequency of 1 MHz. In other embodiments, mid-range dielectric constant materials may be employed, such as from about 20 to about 200, in some embodiments from about 40 to about 150, and in some embodiments, from about 50 to about 100, as determined at a frequency of 1 MHz. The volume resistivity of the dielectric filler may likewise range from about 1×10¹¹ to about 1×10²⁰ ohm-cm, in some embodiments from about 1×10¹² to about 1×10¹⁹ ohm-cm, and in some embodiments, from about 1×10¹³ to about 1×10¹⁸ ohm-cm, such as determined at a temperature of about 20° C. in accordance with ASTM D257-14. The desired properties may be accomplished by selecting a single material having the target volume dielectric constant and/or volume resistivity, or by blending multiple materials together (e.g., insulative and electrically conductive) so that the resulting blend has the desired properties.

Particularly suitable inorganic oxide materials may include, for instance, ferroelectric and/or paraelectric materials. Examples of suitable ferroelectric materials include, for instance, barium titanate (BaTiO₃), strontium titanate (SrTiO₃), calcium titanate (CaTiO₃), magnesium titanate (MgTiO₃), strontium barium titanate (SrBaTiO₃), sodium barium niobate (NaBa₂Nb₅O₁₅), potassium barium niobate (KBa₂Nb₅O₁₅), calcium zirconate (CaZrO₃), titanite (CaTiSiO₅), as well as combinations thereof. Examples of suitable paraelectric materials likewise include, for instance, titanium dioxide (TiO₂), tantalum pentoxide (Ta₂O₅), hafnium dioxide (HfO₂), niobium pentoxide (Nb₂O₅), alumina (Al₂O₃), zinc oxide (ZnO), etc., as well as combinations thereof. Particularly suitable inorganic oxide materials are particles that include TiO₂, BaTiO₃, SrTiO₃, CaTiO₃, MgTiO₃, BaSrTi₂O₆, and ZnO. Of course, other types of inorganic oxide materials (e.g., mica) may also be employed as a dielectric filler.

In one particular embodiment, titanium dioxide (TiO₂) particles may be employed in the polymer composition as a dielectric filler. The particles may be in the rutile or anatase crystalline form, although rutile is particularly suitable due to its higher density and tint strength. Rutile titanium dioxide is commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of steps to yield TiO₂. Preferably, the titanium dioxide particles may be in the rutile crystalline form and made using the chloride process. The titanium dioxide particles may be substantially pure titanium dioxide or may contain other metal oxides, such as silica, alumina, zirconia, etc. Other metal oxides may be incorporated into the particles, for example, by co-oxidizing or co-precipitating titanium compounds with other metal compounds, such as metal halides of silicon, aluminum and zirconium. If co-oxidized or co-precipitated metals are present, they are typically present in an amount 0.1 to 5 wt. % as the metal oxide based on the weight of the titanium dioxide particles. When alumina is incorporated into the particles by co-oxidation of aluminum halide (e.g., aluminum chloride), alumina is typically present in an amount from about 0.5 to about 5 wt. %, and in some embodiments, from about 0.5 to about 1.5 wt. % based on the total weight of the particles. The titanium dioxide particles may also be coated with an inorganic oxide (e.g., alumina), organic compound, or a combination thereof. Such coatings may be applied using a surface wet treatment technique and/or oxidation technique as are known by those skilled in the art. In one embodiment, for example, the titanium dioxide particles may contain a coating that includes alumina, such as in an amount of from about 0.5 to about 5 wt. %, and in some embodiments, from about 1 to about 3 wt. % of the coating.

The shape and size of the dielectric fillers are not particularly limited and may include particles, fine powders, fibers, whiskers, tetrapod, plates, etc. In one embodiment, for instance, the dielectric filler may include particles having an average diameter of from about 0.01 to about 50 micrometers, in some embodiments from about 0.05 to about 10 micrometers, and in some embodiments, from about 0.1 to about 1 micrometer.

ii. Fibrous Filler

A fibrous filler may also be employed in the polymer composition to improve the thermal and mechanical properties of the composition without having a significant impact on electrical performance. To help maintain the desired dielectric properties, such high strength fibers may be formed from materials that are generally insulative in nature, such as glass, ceramics (e.g., alumina or silica), aramids (e.g., Kevlar® marketed by E. I. duPont de Nemours, Wilmington, Del.), polyolefins, polyesters, etc. Glass fibers are particularly suitable, such as E-glass, A-glass, C-glass, D-glass, AR-glass, R-glass, S1-glass, S2-glass, etc.

Although the fibers employed in the fibrous filler may have a variety of different sizes, fibers having a certain aspect ratio can help improve the mechanical properties of the resulting polymer composition. That is, fibers having an aspect ratio (average length divided by nominal diameter) of about 2 or more, in some embodiments about 4 or more, in some embodiments from about 5 to about 50, and in some embodiments, from about 8 to about 40 are particularly beneficial. Such fibrous fillers may, for instance, have a weight average length of about 10 micrometer or more, in some embodiments about 25 micrometers or more, in some embodiments from about 50 micrometers or more to about 800 micrometers or less, and in some embodiments from about 60 micrometers to about 500 micrometers. Also, such fibrous fillers may, for instance, have a volume average length of about 10 micrometer or more, in some embodiments about 25 micrometers or more, in some embodiments from about 50 micrometers or more to about 800 micrometers or less, and in some embodiments from about 60 micrometers to about 500 micrometers. The fibrous fillers may likewise have a nominal diameter of about 5 micrometers or more, in some embodiments about 6 micrometers or more, in some embodiments from about 8 micrometers to about 40 micrometers, and in some embodiments from about 9 micrometers to about 20 micrometers. The relative amount of the fibrous filler may also be selectively controlled to help achieve the desired mechanical and thermal properties without adversely impacting other properties of the composition, such as its flowability and dielectric properties, etc. For example, the fibrous filler may be employed in a sufficient amount so that the weight ratio of the fibrous filler to any optional laser activatable additive is from about 1 to about 5, in some embodiments from about 1.5 about 4.5, and in some embodiments from about 2 to about 3.5. The fibrous filler may, for instance, constitute from about 1 wt. % to about 40 wt. %, in some embodiments from about 3 wt. % to about 30 wt. %, and in some embodiments, from about 5 wt. % to about 20 wt. % of the polymer composition.

iii. Electrically Conductive Filler

If desired, an electrically conductive filler may be employed in the polymer composition to ensure that it achieves the desired dielectric performance. For example, an electrically conductive carbon material may be employed that has a volume resistivity of less than about 1 ohm-cm, in some embodiments about less than about 0.1 ohm-cm, and in some embodiments, from about 1×10⁻⁸ to about 1×10⁻² ohm-cm, such as determined at a temperature of about 20° C. Suitable electrically conductive carbon materials may include, for instance, graphite, carbon black, carbon fibers, graphene, carbon nanotubes, etc. Other suitable electrically conductive fillers may likewise include metals (e.g., metal particles, metal flakes, metal fibers, etc.), ionic liquids, and so forth. When employed, for example, the electrically conductive filler may constitute from about 0.1 wt. % to about 10 wt. %, in some embodiments from about 0.2 wt. % to about 8 wt. %, and in some embodiments, from about 0.5 wt. % to about 6 wt. % of the polymer composition.

iv. Mineral Filler

The polymer composition may also optionally contain one or more mineral fillers distributed within the polymer matrix. When employed, such mineral filler(s) typically constitute from about 1 wt. % to about 50 wt. %, in some embodiments from about 2 wt. % to about 45 wt. %, and in some embodiments, from about 5 wt. % to about 40 wt. % of the polymer composition. The nature of the mineral filler(s) employed in the polymer composition may vary, such as mineral particles, mineral fibers (or “whiskers”), etc., as well as blends thereof. Typically, the mineral filler(s) employed in the polymer composition have a certain hardness value to help improve the mechanical strength, adhesive strength, and surface properties of the composition. For instance, the hardness values may be about 2.0 or more, in some embodiments about 2.5 or more, in some embodiments about 3.0 or more, in some embodiments from about 3.0 to about 11.0, in some embodiments from about 3.5 to about 11.0, and in some embodiments, from about 4.5 to about 6.5 based on the Mohs hardness scale.

Any of a variety of different types of mineral particles may generally be employed in the polymer composition, such as those formed from a natural and/or synthetic silicate mineral, such as talc, mica, silica (e.g., amorphous silica), alumina, halloysite, kaolinite, illite, montmorillonite, vermiculite, palygorskite, pyrophyllite, calcium silicate, aluminum silicate, wollastonite, etc.; sulfates; carbonates; phosphates; fluorides, borates; and so forth. Particularly suitable are particles having the desired hardness value, such as calcium carbonate (CaCO₃, Mohs hardness of 3.0), copper carbonate hydroxide (Cu₂CO3(OH)₂, Mohs hardness of 4.0); calcium fluoride (CaFl₂, Mohs hardness of 4.0); calcium pyrophosphate ((Ca₂P₂O₇, Mohs hardness of 5.0), anhydrous dicalcium phosphate (CaHPO₄, Mohs hardness of 3.5), hydrated aluminum phosphate (AlPO₄·2H₂O, Mohs hardness of 4.5); silica (SiO₂, Mohs hardness of 5.0-6.0), potassium aluminum silicate (KAlSi₃O₈, Mohs hardness of 6), copper silicate (CuSiO₃-H₂O, Mohs hardness of 5.0); calcium borosilicate hydroxide (Ca₂B₅SiO₉(OH)₅, Mohs hardness of 3.5); alumina (AlO₂, Mohs hardness of 10.0); calcium sulfate (CaSO₄, Mohs hardness of 3.5), barium sulfate (BaSO₄, Mohs hardness of from 3 to 3.5), mica (Mohs hardness of 2.5-5.3), and so forth, as well as combinations thereof. Mica, for instance, is particularly suitable. Any form of mica may generally be employed, including, for instance, muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc. Muscovite-based mica is particularly suitable for use in the polymer composition.

In certain embodiments, the mineral particles, such as barium sulfate and/or calcium sulfate particles, may have a shape that is generally granular or nodular in nature. In such embodiments, the particles may have a median size (e.g., diameter) of from about 0.5 to about 20 micrometers, in some embodiments from about 1 to about 15 micrometers, in some embodiments from about 1.5 to about 10 micrometers, and in some embodiments, from about 2 to about 8 micrometers, such as determined using laser diffraction techniques in accordance with ISO 13320:2009 (e.g., with a Horiba LA-960 particle size distribution analyzer). In other embodiments, it may also be desirable to employ flake-shaped mineral particles, such as mica particles, that have a relatively high aspect ratio (e.g., average diameter divided by average thickness), such as about 4 or more, in some embodiments about 8 or more, and in some embodiments, from about 10 to about 500. In such embodiments, the average diameter of the particles may, for example, range from about 5 micrometers to about 200 micrometers, in some embodiments from about 8 micrometers to about 150 micrometers, and in some embodiments, from about 10 micrometers to about 100 micrometers. The average thickness may likewise be about 2 micrometers or less, in some embodiments from about 5 nanometers to about 1 micrometer, and in some embodiments, from about 20 nanometers to about 500 nanometers such as determined using laser diffraction techniques in accordance with ISO 13320:2009 (e.g., with a Horiba LA-960 particle size distribution analyzer). The mineral particles may also have a narrow size distribution. That is, at least about 70% by volume of the particles, in some embodiments at least about 80% by volume of the particles, and in some embodiments, at least about 90% by volume of the particles may have a size within the ranges noted above.

Suitable mineral fibers may likewise include those that are derived from silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Particularly suitable are fibers having the desired hardness value, including fibers derived from inosilicates, such as wollastonite (Mohs hardness of 4.5 to 5.0), which are commercially available from Nyco Minerals under the trade designation Nyglos® (e.g., Nyglos® 4W or Nyglos® 8). The mineral fibers may have a median width (e.g., diameter) of from about 1 to about 35 micrometers, in some embodiments from about 2 to about 20 micrometers, in some embodiments from about 3 to about 15 micrometers, and in some embodiments, from about 7 to about 12 micrometers. The mineral fibers may also have a narrow size distribution. That is, at least about 60% by volume of the fibers, in some embodiments at least about 70% by volume of the fibers, and in some embodiments, at least about 80% by volume of the fibers may have a size within the ranges noted above. In addition to possessing the size characteristics noted above, the mineral fibers may also have a relatively high aspect ratio (average length divided by median width) to help further improve the mechanical properties and surface quality of the resulting polymer composition. For example, the mineral fibers may have an aspect ratio of from about 2 to about 100, in some embodiments from about 2 to about 50, in some embodiments from about 3 to about 20, and in some embodiments, from about 4 to about 15. The volume average length of such mineral fibers may, for example, range from about 1 to about 200 micrometers, in some embodiments from about 2 to about 150 micrometers, in some embodiments from about 5 to about 100 micrometers, and in some embodiments, from about 10 to about 50 micrometers.

v. Plating Additive

If desired, the polymer composition may contain a plating additive to allow certain conductive elements (e.g., antenna elements) to be formed directly on the substrate. In one embodiment, for example, the polymer composition may be “laser activatable” in the sense that it contains a plating additive that can be activated by a laser direct structuring (“LDS”) process. In such a process, the plating additive is exposed to a laser that causes the release of metals. The laser thus draws the pattern of conductive elements onto the part and leaves behind a roughened surface containing embedded metal particles. These particles act as nuclei for the crystal growth during a subsequent plating process (e.g., copper plating, gold plating, nickel plating, silver plating, zinc plating, tin plating, etc.). The laser activatable plating additive generally includes oxide crystals, which may include two or more metal oxide cluster configurations within a definable crystal formation. For example, the overall crystal formation may have the following general formula:

AB₂O₄ or ABO₂
wherein,
A is a metal cation having a valance of 2 or more, such as cadmium, chromium, manganese, nickel, zinc, copper, cobalt, iron, magnesium, tin, titanium, etc., as well as combinations thereof; and
B is a metal cation having a valance of 3 or more, such as antimony, chromium, iron, aluminum, nickel, manganese, tin, etc., as well as combinations thereof.

Typically, A in the formula above provides the primary cation component of a first metal oxide cluster and B provides the primary cation component of a second metal oxide cluster. These oxide clusters may have the same or different structures. In one embodiment, for example, the first metal oxide cluster has a tetrahedral structure and the second metal oxide cluster has an octahedral cluster. Regardless, the clusters may together provide a singular identifiable crystal type structure having heightened susceptibility to electromagnetic radiation. Examples of suitable oxide crystals include, for instance, MgAl₂O₄, ZnAl₂O₄, FeAl₂O₄, CuFe₂O₄, CuCr₂O₄, MnFe₂O₄, NiFe₂O₄, TiFe₂O₄, FeCr₂O₄, MgCr₂O₄, tin/antimony oxides (e.g., (Sb/Sn)O₂), and combinations thereof. Copper chromium oxide (CuCr₂O₄) is particularly suitable for use in the present invention and is available from Shepherd Color Co. under the designation “Shepherd Black 1GM.” In some cases, the laser activatable additive may also have a core-shell configuration, such as described in WO 2018/130972. In such additives, the shell component of the additive is typically laser activatable, while the core may be any general compound, such as an inorganic compound (e.g., titanium dioxide, mica, talc, etc.).

When employed, laser activatable plating additives typically constitute from about 0.1 wt. % to about 30 wt. %, in some embodiments from about 0.5 wt. % to about 20 wt. %, and in some embodiments, from about 1 wt. % to about 10 wt. % of the polymer composition. Of course, the polymer composition may also be free (i.e., 0 wt. %) of such laser activatable additives, such as spinel crystals, or such additives may be present in only a small concentration, such as in an amount of about 1 wt. % or less, in some embodiments about 0.5 wt. % or less, and in some embodiments, from about 0.001 wt. % to about 0.2 wt. %.

In other embodiments, the plating additive may include a noble metal catalyst that can help serve facilitate subsequent plating of the composition. The noble metal catalyst typically contains a noble metal component, such as those selected from Groups IB, VIIA and VIIIA of the Periodic Table (IUPAC Table), generally with atomic weights of at least 100. Examples of such noble metal components include palladium, ruthenium, rhodium, iridium, platinum, as well as alloys or combinations of any of the foregoing. Palladium is particularly suitable. To help improve the physical strength of the catalyst, the noble metal component is also typically supported by a matrix material, such as an inorganic metal oxide. Suitable inorganic metal oxides for this purpose may include, for instance, silica, alumina, silica-alumina, magnesia, silica-magnesia, silica-zirconia, silica-thoria, silica-beryllia, silica-titania, silica-alumina-thoria, silica-alumina-zirconia, silica-alumina-magnesia, silica-magnesia-zirconia, halloysite, kaolinite, illite, montmorillonite, vermiculite, palygorskite, pyrophyllite, calcium silicate, aluminum silicate, wollastonite, etc. Natural and/or synthetic silicates mineral, such as kaolinite, are particularly suitable. The matrix material may be combined with the noble metal component in a variety of ways, such as impregnation or ion exchange (or both), using solutions of simple or complex ions of the chosen metal component (e.g., complex cations, such as Pd(NH₃)₄²⁺). The complex can be converted to the catalytically active form during subsequent treatment steps, such as calcination or reduction e.g. in hydrogen. Alternatively, a compound of the selected noble metal component may simply be added to the matrix material as it is formed into particles, such as by extrusion or pelletizing.

When employed, the overall amount of catalyst employed in the polymer composition is generally such that the noble metal component constitutes from about 0.1 parts to about 6 parts by weight, in some embodiments from about 0.2 parts to about 4 parts by weight, and in some embodiments, from about 0.5 parts to about 2.5 parts by weight per 100 parts by weight of the polymer matrix. For example, the noble metal component may constitute from about 0.1 wt. % to about 5 wt. %, in some embodiments from about 0.2 wt. % to about 3 wt. %, and in some embodiments, from about 0.4 wt. % to about 1.5 wt. % of the polymer composition. The actual amount of catalyst employed in the composition thus depends on the amount of the noble metal component employed within the catalyst. Typically, the noble metal component constitutes from about 0.01 wt. % to about 3 wt. % in some embodiments from about 0.05 wt. % to about 1 wt. %, and in some embodiments, from about 0.1 wt. % to about 0.8 wt. % of the catalyst. In such embodiments, the catalyst constitutes from about 0.5 parts to about 20 parts by weight, in some embodiments from about 1 part to about 15 parts by weight, and in some embodiments, from about 2 parts to about 10 parts by weight per 100 parts by weight of the polymer matrix. For example, the catalyst may constitute from about 0.1 wt. % to about 15 wt. %, in some embodiments from about 0.5 wt. % to about 10 wt. %, and in some embodiments, from about 1 wt. % to about 6 wt. % of the polymer composition.

vi. Other Additives

A wide variety of other additional additives can also be included in the polymer composition, such as lubricants, thermally conductive fillers (e.g., carbon black, graphite, boron nitride, etc.), pigments, antioxidants, stabilizers, surfactants, waxes, flame retardants, anti-drip additives, nucleating agents (e.g., boron nitride), tribological agents (e.g., fluoropolymers), antistatic fillers (e.g., carbon black, carbon nanotubes, carbon fibers, graphite, ionic liquids, etc.), and other materials added to enhance properties and processability. Lubricants, for example, may be employed in the polymer composition that are capable of withstanding the processing conditions of the liquid crystalline polymer without substantial decomposition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % (by weight) of the polymer composition.

### II. Formation

The components used to form the polymer composition may be combined together using any of a variety of different techniques as is known in the art. In one particular embodiment, for example, a liquid crystalline polymer and other optional additives are melt processed as a mixture within an extruder to form the polymer composition. The mixture may be melt-kneaded in a single-screw or multi-screw extruder at a temperature of from about 250° C. to about 450° C. In one embodiment, the mixture may be melt processed in an extruder that includes multiple temperature zones. The temperature of individual zones is typically set within about −60° C. to about 25° C. relative to the melting temperature of the liquid crystalline polymer. By way of example, the mixture may be melt processed using a twin screw extruder such as a Leistritz 18-mm co-rotating fully intermeshing twin screw extruder. A general purpose screw design can be used to melt process the mixture. In one embodiment, the mixture including all of the components may be fed to the feed throat in the first barrel by means of a volumetric feeder. In another embodiment, different components may be added at different addition points in the extruder, as is known. For example, the liquid crystalline polymer may be applied at the feed throat, and certain additives (e.g., dielectric filler) may be supplied at the same or different temperature zone located downstream therefrom. Regardless, the resulting mixture can be melted and mixed then extruded through a die. The extruded polymer composition can then be quenched in a water bath to solidify and granulated in a pelletizer followed by drying.

### III. Substrate

Once formed, the polymer composition may be shaped into a substrate for use in an antenna package as noted above. Due to the beneficial properties of the polymer composition, the substrate typically has a small size, such as a thickness of from about 10 to about 600 micrometers, in some embodiments about from about 20 to about 500 micrometers, and in some embodiments, from about 30 to about 400 micrometers (e.g., about 100 or 300 micrometers). The substrate may be formed as a film, thermoformed layer, molded part, etc. In one embodiment, for instance, the substrate may be in the form of a film. Any of variety of different techniques may generally be used to form the composition into a film. Suitable techniques may include, for instance, solvent casting, extrusion casting, blown film processes, tubular trapped bubble film processes, flat or tube cast film processes, slit die flat cast film processes, etc. In one particular embodiment, a blown film process is employed in which the composition is fed to an extruder, where it is melt processed and then supplied through a blown film die to form a molten bubble. Typically, the die contains a mandrel that is positioned within the interior of an outer die body so that a space is defined therebetween. The polymer composition is blown through this space to form the bubble, which can then be drawn, inflated with air, and rapidly cooled so that the polymer composition quickly solidifies. If desired, the bubble may then be collapsed between rollers and optionally wound onto a reel.

### IV. Antenna Package

As indicated above, the substrate may be used in an antenna package, such as an antenna-in-package (AiP). Some suitable package types may include, but not limited to, a fan-out wafer level package (FOWLP), a flip-chip chip-scale package (FCCSP), or a semiconductor-embedded in substrate (SESUB). Regardless, the antenna generally contains one or more antenna elements positioned adjacent to at least a first side of the substrate. The antenna elements may be formed in a variety of ways, such as by plating, electroplating, laser direct structuring, etc. When containing spinel crystals as a laser activatable additive, for instance, activation with a laser may cause a physio-chemical reaction in which the spinel crystals are cracked open to release metal atoms. These metal atoms can act as a nuclei for metallization (e.g., reductive copper coating). The laser also creates a microscopically irregular surface and ablates the polymer matrix, creating numerous microscopic pits and undercuts in which the copper can be anchored during metallization.

Antennas of a variety of different types, can be formed on the substrate, such as antennas that include resonating elements formed from loop antenna structures, patch antenna structures, stacked patch antenna structures, antenna structures having parasitic elements, inverted-F antenna structures, slot antenna structures, planar inverted-F antenna structures, monopoles, dipoles, helical antenna structures, surface integrated waveguide structures, hybrids of these designs, etc. The antenna can be arranged in a phased antenna array for handling millimeter wave and centimeter wave communications. The radiating elements in a phased antenna array for supporting millimeter wave communications may be patch antennas, dipole antennas, or other suitable antenna elements. Transceiver circuitry can be integrated with the phased antenna array to form integrated phased antenna array and transceiver circuit modules if desired. In one embodiment, for instance, the phase array antenna may contain a first antenna subassembly coupled to a first transmission line path 64-1, a second antenna subassembly coupled to a second transmission line path, an Nth antenna coupled to an Nth transmission line path, etc. The antenna elements in the phased antenna array may be arranged in any desired number of rows and columns or in any other desired pattern (e.g., the antennas need not be arranged in a grid pattern having rows and columns). During signal transmission operations, transmission line paths may supply signals (e.g., radio-frequency signals, such as millimeter wave and/or centimeter wave signals) from transceiver circuitry to the phased antenna array for wireless transmission to external wireless equipment.

The use of multiple antenna subassemblies in a phased antenna array may allow beam steering arrangements to be implemented by controlling the relative phases and magnitudes (amplitudes) of the radio-frequency signals conveyed by the antennas. For example, the antenna subassemblies each have a corresponding radio-frequency phase and magnitude controller (e.g., a first phase and magnitude controller interposed on transmission line path may control phase and magnitude for radio-frequency signals handled by an antenna subassembly). The phase and magnitude controllers may each include circuitry for adjusting the phase of the radio-frequency signals on transmission line paths (e.g., phase shifter circuits) and/or circuitry for adjusting the magnitude of the radio-frequency signals on transmission line paths (e.g., power amplifier and/or low noise amplifier circuits). The phase and magnitude controllers may sometimes be referred to collectively herein as beam steering circuitry (e.g., beam steering circuitry that steers the beam of radio-frequency signals transmitted and/or received by phased antenna array). The term “beam” or “signal beam” may be used herein to collectively refer to wireless signals that are transmitted and received by phased antenna array in a particular direction. The term “transmit beam” may sometimes be used herein to refer to wireless radio-frequency signals that are transmitted in a particular direction whereas the term “receive beam” may sometimes be used herein to refer to wireless radio-frequency signals that are received from a particular direction. If, for example, the phase and magnitude controllers are adjusted to produce a first set of phases and/or magnitudes for transmitted millimeter wave signals, the transmitted signals will form a millimeter wave frequency transmit beam oriented in a first direction. If, however, the phase and magnitude controllers are adjusted to produce a second set of phases and/or magnitudes for the transmitted millimeter wave signals, the transmitted signals will form a millimeter wave frequency transmit beam oriented in a second direction.

Any desired antenna elements may be used to form the antenna. In one suitable embodiment, patch antenna elements may be employed. The antenna may, for example, have a patch antenna resonating element separated from and parallel to a ground plane. The length of the sides of patch element may be selected so that the antenna resonates at a desired operating frequency. For example, the sides of patch element may each have a length that is approximately equal to half of the wavelength of the signals conveyed by antenna (e.g., the effective wavelength given the dielectric properties of the materials surrounding patch element). In one suitable arrangement, the length may be between 0.8 mm and 1.2 mm (e.g., approximately 1.1 mm) for covering a millimeter wave frequency band between 57 GHz and 70 GHz or between 1.6 mm and 2.2 mm (e.g., approximately 1.85 mm) for covering a millimeter wave frequency band between 37 GHz and 41 GHz, as just two examples.

A semiconductor device (e.g., monolithic microwave integrated circuit), a DSP, an ASIC, a FPGA, or other programmable logic device) is also electrically coupled to the antenna through the substrate. This may be accomplished in a variety of ways as is known in the art. In one embodiment, for example, the semiconductor device may be embedded within the substrate. Alternatively, the semiconductor may be mounted externally to the substrate, such as adjacent to a second side of the substrate that opposes the first side of the substrate adjacent to which the antenna is disposed. Regardless of the configuration, the substrate may contain one or more connectors (e.g., vias, solder bumps, contact pads, etc.) that can electrically couple the semiconductor device to the antenna. Optionally, the antenna package may also contain a redistribution layer that is positioned adjacent to the second side of the substrate such that the semiconductor device is electrically coupled to the redistribution layer. The redistribution layer may contain a conductive layer that is electrically coupled to the semiconductor device.

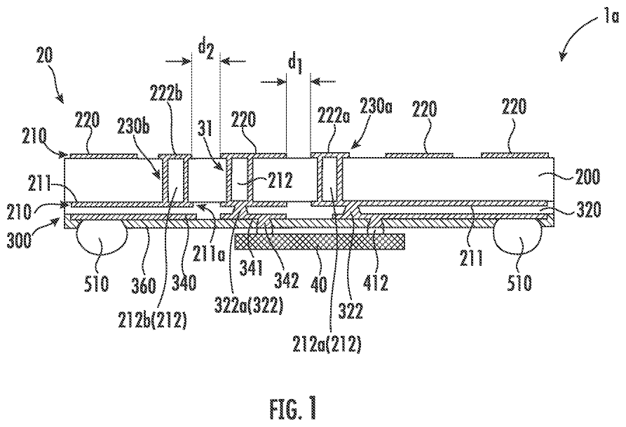

Referring to FIG. 1, for example, one embodiment of an antenna package 1a is shown that contains an antenna 20 that is configured to transmit and/or receive wireless communications at a millimeter wave frequency. In the illustrated embodiment, the antenna 20 contains a conductive layer 210 formed on an at least an upper surface of the substrate 200. In the illustrated embodiment, a conductive layer 210 is also located on a lower surface of the substrate 200, but this is by no means required. The substrate 200 typically contains at least one connector 212, such as a plated through-hole or via, to route signals from one side of the substrate 200 to the other side of the substrate 200. A redistribution layer 300 may also be disposed on a second side of the substrate 200, for example, on a bottom surface of the substrate 200. The redistribution layer 300 may, for example, contain a dielectric layer 320 laminated on the bottom surface of the substrate 200, a conductive layer 340 patterned on the dielectric layer 320, and a protective layer 360 disposed on the interconnect layer 340. The conductive layers (e.g., conductive layer 340, conductive layer(s) 210, etc.) may be one or more layers of Al, Cu, Sn, Ni, Au, Ag, or other suitable electrically conductive material, as is known in the art. The dielectric layer 320 may contain any suitable insulating layers, such as silicon oxide, silicon nitride, polyimide, etc. The protective layer 360 may contain any suitable passivation layers, solder masks, etc. The conductive layer 340 may be electrically connected to the conductive layer 210 through the vias 322 in the dielectric layer 320. A semiconductor device 40 may also be mounted on the redistribution layer 300. The semiconductor device 40 may be electrically connected to the conductive layer 340 through contact elements 342 and conductive elements 412, such as conductive bumps, pillars or balls. Solder balls 510 (e.g., ball grid array) may also be provided around the semiconductor device 40 and may be electrically connected to the conductive layer 340 of the redistribution layer 300. The solder balls 510 may be Al, Cu, Sn, Ni, Au, Ag, lead (Pb), bismuth (Bi), solder, or combinations thereof, with an optional flux solution, as is known in the art.

The antenna 20 may include a radiative antenna element 220, which may be disposed in the conductive layer 210 on a top surface of the substrate 200. The radiative antenna element 220 may contain a phased antenna array or a mechanism for radiating and/or receiving electro-magnetic signals, such as described above. Although not shown in this figure, it is understood that the radiative antenna element 220 may also be disposed at a bottom surface of the substrate 200 depending upon the design requirements. The conductive layer 340 may include a transmission line 341 (or transmission trace) of a feeding network for transmitting RF signals or mmW signals. One end of the transmission line 341 may be electrically coupled to a feeding terminal 31, which includes a connector 212 (e.g., plated through hole) in the substrate 200 and a via 322a in the redistribution layer 300. The other end of the transmission line 341 may be electrically coupled to a pad of the semiconductor device 40. In one embodiment, the connector 212 may be aligned with the via 322a. An upper end of the feeding terminal 31 may be electrically coupled to the radiative antenna element 220. The RF signals to or from the radiative antenna element 220 may be transmitted through the transmission line 341 in the conductor layer 340 and the feeding terminal 31.

As shown, the substrate 200 may include a solid ground plane 211 in the conductive layer 210 of the substrate 200. The ground plane 211, which is also referred to as a reflector ground plane, functions as a ground reflector of the antenna 20. For example, the ground plane 211 may be disposed on the bottom surface of the substrate 200 and include an aperture 211a for accommodating the feeding terminal 31. The connector 212 of the feeding terminal 31 may pass through the aperture 211a so that it is not in contact with the ground plane 211. The substrate 200 may also contain at least one coupling element that is capacitively coupled with the feeding terminal 31. For example, as shown in FIG. 1, two coupling elements 230a and 230b may be disposed in proximity to the feeding terminal 31. The coupling element 230a may contain a conductive pad 222a and a connector 212a (e.g., plated through hole or via) that electrically couples the conductive pad 222a to the ground plane 211. The coupling element 230b may likewise contain a conductive pad 222b and a connector 212b that electrically couple the conductive pad 222b to the ground plane 211. In certain embodiments, the distance d₁ between the conductive pad 222a and the radiative antenna element 220 may be equal to or smaller than 0.4λ. The distance d₂ between the conductive pad 222b and the radiative antenna element 220 may be equal to or smaller than 0.4λ.

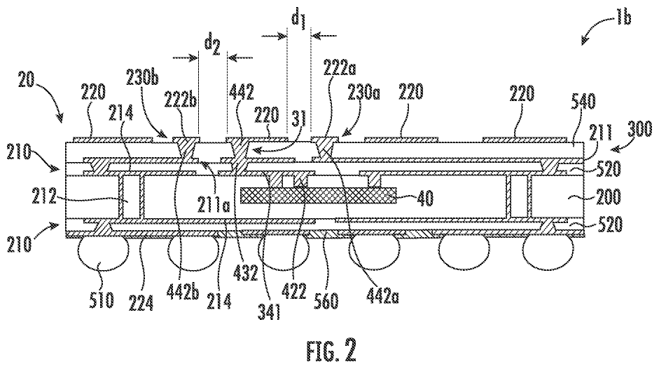

In the embodiment of FIG. 1, dielectric layers (i.e., dielectric layer 320) are generally only formed on side of the substrate 200. It should be understood, however, that dielectric layers may be formed on both sides of the substrate as is known in the art. Referring to FIG. 2, for example, another embodiment of an antenna package 1b is shown that contains dielectric layers 520 and conductive traces 214, 224 formed on opposite surfaces of the substrate 200. In this embodiment, a protective layer 560 may be disposed to cover the conductive trace 224 and the dielectric layers 520. The antenna 20 may be fabricated on an upper surface of the substrate 200 and may contain a radiative antenna element 220 disposed on a surface of the dielectric layer 540. Similar to the embodiment shown in FIG. 1, a transmission line 341 may be disposed in the conductive layer 210. One end of the transmission line 341 is electrically coupled to a feeding terminal 31 that is comprised of a via 432 in the dielectric layer 520 and a via 442 in the dielectric layer 540. The via 442 may be aligned with the via 432. An upper end of the feeding terminal 31 may be electrically coupled to the radiative antenna element 220. Also, as discussed above, a ground plane 211 may be disposed on the dielectric layer 520 and the ground plane 211 may also include an aperture 211a for accommodating the feeding terminal 31. The vias 432 and 442 of the feeding terminal 31 may pass through the aperture 211a of the ground plane 211 and is not in contact with the ground plane 211. Two coupling elements 230a and 230b may be disposed in proximity to the feeding terminal 31. According to one embodiment, the coupling element 230a may include a conductive pad 222a and a via 442a that electrically couple the conductive pad 222a to the ground plane 211. The coupling element 230b may likewise include a conductive pad 222b and a via 442b that electrically couple the conductive pad 222b to the ground plane 211. In certain embodiments, the distance d₁ between the conductive pad 222a and the radiative antenna element 220 may be equal to or smaller than 0.4λ. The distance d₂ between the conductive pad 222b and the radiative antenna element 220 may be equal to or smaller than 0.4λ.

In FIG. 2, a semiconductor device 40 is also embedded in the substrate 200. Although not shown, a redistribution layer may also be connected to the semiconductor device 40. Of course, if so desired, the semiconductor device 40 may also be mounted externally on a redistribution layer that is disposed adjacent to the substrate, as described above and shown in FIG. 1.

The resulting antenna package can be employed in a variety of different electronic components. As an example, the antenna package may be formed in electronic components, such as desktop computers, portable computers, handheld electronic devices, automotive equipment, etc. In one suitable configuration, the antenna package is contained within the housing of a relatively compact portable electronic component in which the available interior space is relatively small. Examples of suitable portable electronic components include cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, etc. The antenna package could also be integrated with other components such as camera module, speaker or battery cover of a handheld device.

The present invention may be better understood with reference to the following example.

### TEST METHODS

Melt Viscosity: The melt viscosity (Pa-s) may be determined in accordance with ISO 11443:2021 at a shear rate of 400 s⁻¹ or 1,000 s⁻¹ and temperature 15° C. above the melting temperature (e.g., about 325° C.) using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod may be 233.4 mm.

Melting Temperature: The melting temperature (“Tm”) may be determined by differential scanning calorimetry (“DSC”) as is known in the art. The melting temperature is the differential scanning calorimetry (DSC) peak melt temperature as determined by ISO 11357-3:2018. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO 75-2:2013 (technically equivalent to ASTM D648). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Tensile Modulus, Tensile Stress, and Tensile Elongation: Tensile properties may be tested according to ISO 527:2019 (technically equivalent to ASTM D638). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation: Flexural properties may be tested according to ISO 178:2019 (technically equivalent to ASTM D790). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010 (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

Dielectric Constant (“Dk”) and Dissipation Factor (“Df”): The dielectric constant (or relative static permittivity) and dissipation factor may be determined at a frequency range of 17-65 GHz using CAVITYTM (flexible software package), FPOR (Fabry-Perot open resonator, Model 600T, Damaskos Inc.), Keysight PNA N5247B network analyzer, and Microsoft Window compatible PC with a National instruments GPIB interface. For measurements in the 15-30 GHz frequency range, the spacing that the sample is placed between two resonators is 5 inches. For measurements in the 31-65 GHz frequency range, the spacing that the sample is placed between two resonators is 10.5 inches. The sample may be in the form of a film having a size of 110 mm×110 mm×0.3 mm. The film sample may be formed using a single-screw extruder (25 or 35 mm general purpose screw) and a 4-inch wide fixed-gap head with a 0.5-mm gap. Because a fixed-gap die is employed, the film sample may be pulled down from the 0.5 mm thickness to the target thickness of 0.3 mm. The polymer composition may be dried at 275° C. for 4 hours prior to film extrusion.

Surface/Volume Resistivity: The surface and volume resistivity values may be determined in accordance with IEC 62631-3-1:2016 or ASTM D257-14. According to this procedure, a standard specimen (e.g., 1 meter cube) is placed between two electrodes. A voltage is applied for sixty (60) seconds and the resistance is measured. The surface resistivity is the quotient of the potential gradient (in V/m) and the current per unit of electrode length (in A/m), and generally represents the resistance to leakage current along the surface of an insulating material. Because the four (4) ends of the electrodes define a square, the lengths in the quotient cancel and surface resistivities are reported in ohms, although it is also common to see the more descriptive unit of ohms per square. Volume resistivity is also determined as the ratio of the potential gradient parallel to the current in a material to the current density. In SI units, volume resistivity is numerically equal to the direct-current resistance between opposite faces of a one-meter cube of the material (ohm-m or ohm-cm).

### EXAMPLE

A sample is formed from various combinations of 49 wt. % of a liquid crystalline polymer (LCP 1), 30 wt. % of titanium dioxide particles (chloride-process rutile containing alumina and hydrophobic organic surface treatment, average particle size of 0.27 pm), 15 wt. % glass fibers, 1 wt. % aluminum trihydrate, and 5 wt. % of a black pigment. LCP 1 is formed from 43% HBA, 8.5% TA, 28.5% HQ, and 20% NDA. Compounding was performed using an 18-mm single screw extruder. Parts are injection molded the samples into plaques (60 mm×60 mm). The sample is tested for thermal and mechanical properties and the results are set forth in the table below.

| | |
|---|---|
| Dielectric Constant (17 GHz) | 5.78 |
| Dissipation Factor (17 GHz) | 0.0027 |
| DTUL at 1.8 MPa (° C.) | 276 |
| Charpy Unnotched (kJ/m²) | 36 |
| Charpy Notched (kJ/m²) | 30 |
| Tensile Strength (MPa) | 125 |
| Tensile Modulus (MPa) | 14,260 |
| Tensile Elongation (%) | 2.5 |
| Flexural Strength (MPa) | 190 |
| Flexural Modulus (MPa) | 12,200 |
| Melt Viscosity (Pa-s) at 1,000 s⁻¹ | 50 |
| Melting Temperature (° C., 1^{st} heat of DSC) | 315 |

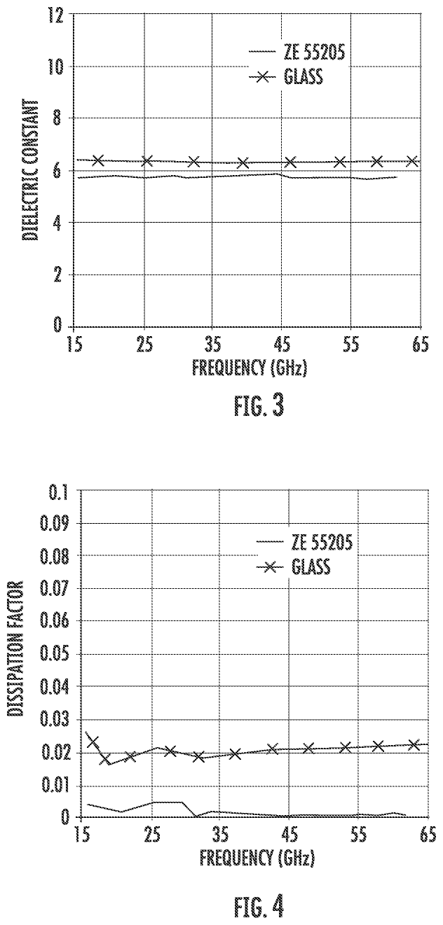

In addition, FIGS. 3-4 illustrate the dielectric constant and dissipation factor of the sample in comparison to a conventional glass substrate over a frequency range of 17 to 60 GHz.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. An antenna package comprising:
a substrate comprising a polymer composition, wherein the polymer composition includes a polymer matrix containing a thermotropic liquid crystalline polymer, wherein the polymer composition exhibits a dissipation factor of about 0.1 or less as determined at a frequency of 17 GHz and a dielectric constant of about 4 more as determined at a frequency of 17 GHz;
an antenna containing one or more antenna elements positioned adjacent to a first side of the substrate, wherein the antenna is configured to transmit and/or receive wireless communications at a millimeter wave frequency; and
a semiconductor device that is electrically coupled to the antenna through the substrate.

2. The antenna package of claim 1, wherein one or more vias are formed in the substrate for electrically coupling the antenna to the semiconductor device.

3. The antenna package of claim 1, wherein the semiconductor device is embedded within the substrate.

4. The antenna package of claim 1, further comprising a redistribution layer that is positioned to a second side of the substrate, wherein the semiconductor device is electrically coupled to the redistribution layer.

5. The antenna package of claim 4, wherein the redistribution layer contains a conductive layer that is electrically coupled to the semiconductor device.

6. The antenna package of claim 5, wherein the conductive layer includes antenna elements.

7. The antenna package of claim 1, wherein the semiconductor device is a monolithic microwave integrated circuit.

8. The antenna package of claim 1, wherein the substrate has a thickness of from about 10 to about 600 micrometers.

9. The antenna package of claim 1, wherein the polymer composition exhibits a melt viscosity of from about 0.1 to about 100 Pa-s as determined at a shear rate of 1,000 s⁻¹ and a temperature of about 15° C. about greater than a melting temperature of the polymer composition.

10. The antenna package of claim 1, wherein the polymer composition has a melting temperature of from about 280° C. to about 400° C.

11. The antenna package of claim 1, wherein polymer composition exhibits a deflection temperature under load of about 200° C. or more as determined at 1.8 MPa.

12. The antenna package of claim 1, wherein liquid crystalline polymers constitute from about 30 wt. % to about 90 wt. % of the polymer composition.

13. The antenna package of claim 1, wherein the thermotropic liquid crystalline polymer is a high naphthenic polymer that includes repeating units derived from naphthenic hydroxycarboxylic and/or dicarboxylic acids in an amount of about 10 mol. % or more.

14. The antenna package of claim 1, wherein the thermotropic liquid crystalline polymer contains repeating units derived from one or more aromatic dicarboxylic acids, one or more aromatic hydroxycarboxylic acids, or a combination thereof.

15. The antenna package of claim 14, wherein the aromatic hydroxycarboxylic acids include 4-hydroxybenzoic acid, 6-hydroxy-2-naphthoic acid, or a combination thereof.

16. The antenna package of claim 14, wherein the aromatic dicarboxylic acids include terephthalic acid, isophthalic acid, 2,6-naphthalenedicarboxylic acid, or a combination thereof.

17. The antenna package of claim 14, wherein the thermotropic liquid crystalline polymer further contains repeating units derived from one or more aromatic diols.

18. The antenna package of claim 17, wherein the aromatic diols include hydroquinone, 4,4′-biphenol, or a combination thereof.

19. The antenna package of claim 1, wherein the thermotropic liquid crystalline polymer is wholly aromatic.

20. The antenna package of claim 1, wherein the polymer composition contains a dielectric filler distributed within the polymer matrix.

21. The antenna package of claim 20, wherein the dielectric filler has a dielectric constant of about 50 or more as determined at a frequency of 1 MHz.

22. The antenna package of claim 20, wherein the dielectric filler includes titanium dioxide particles.

23. The antenna package of claim 20, wherein the polymer composition contains from about 10 wt. % to about 60 wt. % of the dielectric filler.

24. The antenna package of claim 1, wherein the polymer composition contains a fibrous filler.

25. The antenna package of claim 24, wherein the fibrous filler includes glass fibers.

26. The antenna package of claim 1, wherein the polymer composition contains a plating additive.

27. The antenna package of claim 1, wherein the polymer composition exhibits a dissipation factor of about 0.1 or less over a frequency range of from 17 GHz to 60 GHz.

28. The antenna package of claim 1, wherein the polymer composition exhibits a dielectric constant of about 4 or more over a frequency range of from 17 GHz to 60 GHz.

29. The antenna package of claim 1, wherein the ratio of the dielectric constant of the polymer composition at 60 GHz to the dielectric constant of the polymer composition at 16 GHz is from about 0.7 to about 1.3.

30. The antenna package of claim 1, wherein the ratio of the dissipation factor of the polymer composition at 60 GHz to the dissipation factor of the polymer composition at 16 GHz is from about 0.7 to about 1.3.
